(19) United States
(12) Patent Application Publication
(10) Pub. No.: US 2004/0245264 A1
(43) Pub. Date: Dec. 9, 2004

(54) Apparatus for dispensing tickets

(76) Inventor: Kenneth J. Mellet, West Perth, WA (US)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/825,225

(22) Filed: Apr. 16, 2004

Related U.S. Application Data
(63) Continuation of application No. 09/646,678, filed on Sep. 20, 2000, now abandoned.

(30) Foreign Application Priority Data
Mar. 20, 1998 (AU) PP2508

(51) Int. Cl. B65G 59/00; B65H 3/02; G07F 11/16

(52) U.S. Cl. 221/26

(57) ABSTRACT

An apparatus for dispensing a selectable number of tickets from a plurality of serially joined tickets includes a platform on which the joined tickets are supported, a first roller mechanism for engaging the joined tickets and advancing the tickets in a forward direction, a cutting mechanism for cutting adjacent joined tickets along a cut line extending across the platform, a controller housed in the platform and connected to the first roller mechanism and the cutting mechanism, and a detector mechanism coupled to the controller. The detector mechanism detects when adjacent joined tickets are on opposite sides of the cut line and provides information to the controller to enable the controller to count a selected number of tickets. The controller controls the first roller mechanism and the cutting mechanism to advance, cut and dispense a selected number of tickets from the joined tickets.

### FIELD OF THE INVENTION

The present invention relates to an apparatus for dispensing tickets and the like from a bulk stock or roll of joined tickets.

### BACKGROUND OF THE INVENTION

The present invention was inspired by a desire to provide a relatively simple dispenser for dispensing instant lottery tickets. However, as will be apparent from the following description, embodiments of the dispensing apparatus can be used for dispensing any type of ticket, coupon or other printed matter or other article that is held on a continuous roll of paper or plastics material.

An example of a currently available dispensing apparatus for lottery tickets is described in international application numbers PCT/AU97/00221 and PCT/AU96/00662 both in the name of Lottery Products Pty Ltd. The described dispensers include, among other things, a dispensing unit which houses a stock of lottery tickets which are typically joined in a fan fold manner. The dispensing unit is provided with a plurality of rollers that define a tortuous delivery path through which the tickets are pulled in order to be directed to a dispensing outlet. The dispensing unit also includes a pivotable arm designed to fold over the forward most ticket and cut it from the trailing stock so that it can fall through the dispensing opening. The unit described in the aforementioned international applications appears to function relatively well. However, it is believed that every turn in a tortuous path for tickets provides an opportunity of jamming. Further, as a result of the tortuous delivery path the actual dispensing unit is relatively large and bulky.

### SUMMARY OF THE INVENTION

It is an object of the present invention to provide a dispensing apparatus for tickets and the like which is of relatively simple construction and provides a more direct path for tickets from a bulk supply to a dispensing opening.

According to the present invention there is provided an apparatus for dispensing a selectable number of tickets from a plurality of serially joined tickets, the apparatus including:

a platform along which the joined tickets are constrained to travel toward a discharge opening in the apparatus;

first roller means for engaging the joined tickets and advancing the tickets in a forward direction towards the discharge opening;

cutting means adapted to cut adjacent joined tickets along a cut line; and,

a controller connectable to an input device for allowing entry of a selected number of tickets to be dispensed, said controller controlling the first roller and the cutting head to advance the joined tickets a distance in the forward direction commensurate with the selected number of tickets to be dispensed and cutting the selected number of tickets from the joined tickets whereby the selected number of tickets can be dispensed through the discharge opening.

Preferably said apparatus further includes detector means supported on said platform for detecting when said joined tickets are on opposite sides of said cut line and providing information to said controller to enable the controller to count to said selected number of tickets.

Preferably said detector includes first and second sensors on each side of said cut line, each sensor adapted to sense the presence of a different marker on adjacent joined tickets.

Preferably said cutting means is adapted to cut a ticket from the joined tickets when moving in opposite directions along said cut line.

Preferably said cutting means is a rotatable cutting disc.

Preferably said cutting disc is supported on a carriage mounted on a rail extending parallel to and behind said cut line, said rail disposed closed to said platform to assist in holding said joined tickets substantially flat against said platform.

Preferably said apparatus further includes holding means for holding the joined tickets substantially flat against the platform at a location above the detector means.

Preferably said apparatus further includes a ticket guide for constraining and guiding said joined tickets from a supply of said joined tickets onto said platform, said guide demountably coupled to the platform to allow interchanging of the ticket guide to suit joined tickets of different width.

Preferably said first roller means includes a pair of parallel and spaced apart axles, and a plurality of rollers fixed to each axle, wherein the rollers on one axle contact the rollers of the other axle.

Preferably the rollers of one axle are off set relative to the corresponding contacting rollers of the other axle.

According to another aspect of the present invention there is provided a ticketing system including:

a supply of tickets serially joined in a line, each ticket provided on one side with two spaced apart markers, each marker being located along the opposite edges of the ticket that are joined to opposite adjacent tickets; and,

an apparatus for dispensing a selectable number of said joined tickets, the apparatus having:

a platform along which joined tickets are constrained to travel toward a discharge opening in the apparatus;

first roller means for engaging the joined tickets and advancing the tickets in a forward direction to the dispenser opening;

cutting means adapted to cut adjacent joined tickets along a cut line formed of said platforms;

detector means supported on said platform for detecting when respective markers on adjacent joined tickets are located on opposite sides of said cut line; and,

a controller connectable to an input device for allowing entry of the selected number of tickets to be dispensed, said controller controlling the first roller means and the cutting head to advance the joined tickets a distance in the forward direction commensurate with the selected number of tickets to be dispensed and cutting the selected number of tickets from the joined tickets, said detecting means providing a feed back signal to the controller to enable the controller to count to said selected number whereby the selected number of tickets can be dispensed through the dispenser opening.

### BRIEF DESCRIPTION OF THE DRAWINGS

An embodiment of the present invention will now be described by way of example only with reference to the accompanying drawings in which:

FIG. 1 is a perspective view from one side of an embodiment of the apparatus for dispensing tickets;

FIG. 2 is a perspective view from an opposite side of the apparatus shown in FIG. 1; and,

FIG. 3 is a plan view of the back side of tickets that can be dispensed through the apparatus showing in FIGS. 1 and 2.

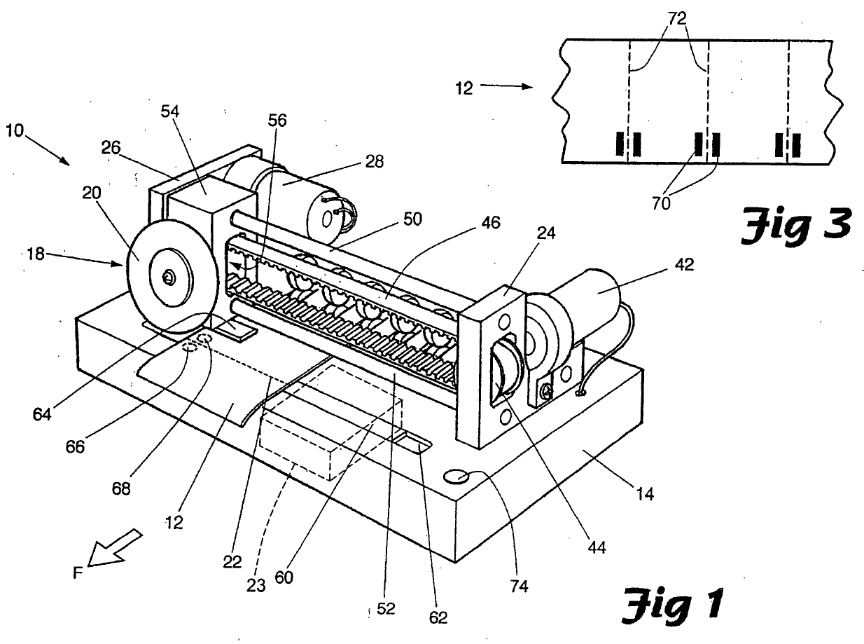

### DETAILED DESCRIPTION OF THE PREFERRED EMBODIMENT

The apparatus 10 for dispensing a selectable number of tickets 12 from a plurality or stock of serially joined tickets (not shown) includes a platform 14 along which the tickets 12 are constrained to travel toward a discharge opening (not shown) in the apparatus 10. First roller means 16 is supported on platform 14 for engaging the joined tickets 12 and advancing them in a forward direction F toward the discharge opening. Cutting means 18 which includes a table cutting disc is supported on a platform 14 for cutting adjacent joined tickets 12 along a cut line 22. A controller (not shown) in the form of a programmable controller is mounted on a circuit board held within a cavity (not shown) formed in the underside of platform 14. The controller can be connected to an input device for allowing entry of a selected number of tickets 12 to be dispensed, and controls the roller means 16 and the cutting means 18 to advance the joined tickets a distance in the forward direction F commensurate with the selected number of tickets to be dispensed and cut the selected number of tickets from adjoined tickets so that the selected number of tickets can be dispensed through the discharge opening.

Typically, the platform 14 is in the form of a slab of mouldable plastics material. Two upstanding support walls 24 and 26 are attached near, but inboard of, opposite ends of the platform 14. An electric motor 28 is attached to the wall 26 on a side nearest wall 24. The output shaft of the motor 28 passes through the wall 26 and has fixed to it a gear wheel 30. The gear wheel 30 meshes with a further gear 32 that in turn is fixed to one end of an axle 34 that passes through the wall 26. The axle 34 forms part of the first roller means 16 which also includes four spaced apart roller wheels 36 mounted on the axle 34, a second axle (not visible in the figures) and a second plurality of roller wheels 38 mounted on the second axle. Rollers 36 and axle 34 contact respective rollers 38 on the second axle. In this particular embodiment, rollers 36 and 38 are not in exact alignment but rather are offset to one side. An end of the axle 34 opposite that containing the gear 32 is rotatably held within a mounting block 40 of a second motor 42 located adjacent the support wall 24. When motor 28 is provided with operating power, its output shaft causes gear 30 to rotate which, by virtue of its meshing with gear 32, causes rotation of the axle 34 and thus the rollers 36. Due to the contact between rollers 36 and 38, rollers 38 are also caused to rotate but in a counter direction to rollers 36.

The motor 42 is operable for driving the cutting disc 20. To this end, an output shaft of the motor 42 passes through the support wall 26 and has, fixed to its end, a drive sprocket 44. A toothed belt 46 engages the drive sprocket 44 at one end and turns about an idler sprocket 48 at an opposite end. The idler sprocket 48 is rotatably mounted within the wall 26. A pair of parallel and spaced apart rails 50 and 52 extend between walls 24 and 26. The lower rail 42 extends parallel to and behind the cutting line 22 and is disposed close to the upper surface of the platform 14. Belt 46 extends between the rails 50 and 52.

The cutting disc 20 is rotatably mounted on a carriage block 54 which is slidably mounted on the rails 50 and 52. Carriage 54 is provided with a recess 56 through which the belt 46 extends. A drive wheel (not shown) is fixably mounted in the recess 56 and engages the teeth on the upper run only of the belt 46. Thus, as the belt 46 is driven by the motor 42 and drive sprocket 44, the carriage 54 is slid along the rails 50 and 52 in a straight line toward wall 24. When the direction of rotation of motor 42 is reversed, the carriage 54 is slid in the opposite direction along rails 50,52 toward wall 26. The cutting disc 20 is not driven as such however it does rotate about its axis by physical contact of its peripheral cutting edge with a cutting block 60 mounted within a slot 62 formed on the upper surface of the platform 14. The cutting block 60 includes the cut line 22 and ideally may be in the form of a sharping stone formed with a longitudinal groove that defines the cut line 22.

Mounted on opposite sides of the cut line 22 is a detector means comprising separate optical sensors 66 and 68. The sensors 66,68 are connected to the controller mounted within the platform 14 and detect the presence of markers 70 printed on the back of the tickets 12. Referring to FIG. 3, it can be seen that each ticket 12 is provided with a pair of markers 70. The markers are located adjacent perforation lines 72 of the adjacent joined tickets 12. The spacing of the sensors 66,68 and the spacing of markers 70 of adjacent tickets 12 is the same. Thus, when the sensors 66 and 68 simultaneously detect the presence of markers 70, the tickets 12 are juxtaposed on the platform 14 so that the perforation line 72 is in alignment with the cut line 22. Extending parallel to the cut line 22 and adjacent the upper surface of the platform 14 is a foot 64 for holding the joined tickets 12 substantially flat against the platform 14 above the sensors 66,68.

A load/unload button 74 is also accessible through a hole in the upper surface of the platform 14. The button 74 is also connected to the controller and operates in a toggle manner so that on a first depression, it operates motor 28 to drive the rollers 16 in a manner to load tickets onto the platform 14 and when depressed again, it reverses a rotation of the motor 28 and roller 16 to unload the tickets from the platform 14.

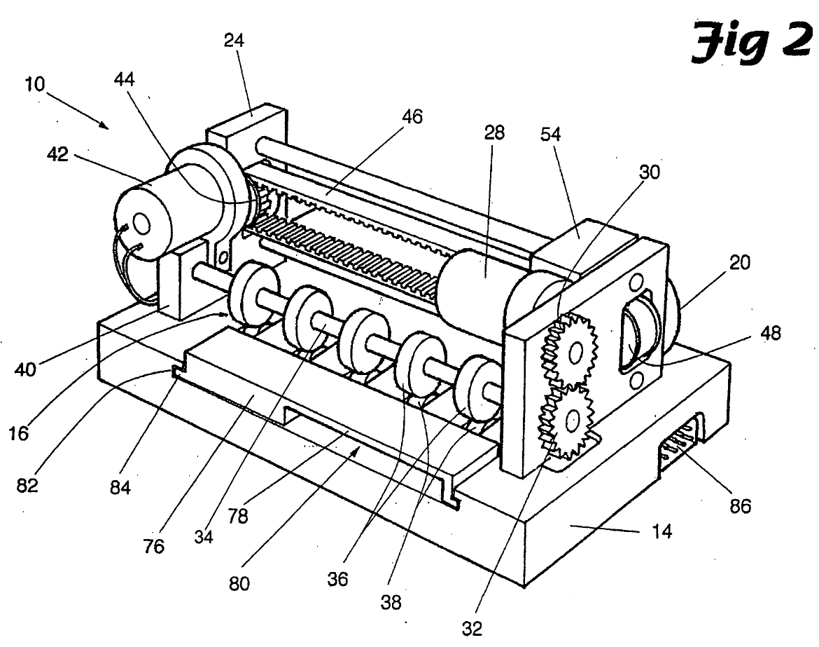

Referring to FIG. 2, the apparatus 10 also includes a ticket guide 76 for constraining lateral motion of the tickets 12, removably mounted on or in the upper surface of the platform 14. The guide 76 is generally in the form of a rectangular block provided with a length of reduced thickness 78 which together with the opposing surface of the platform 14 forms a channel or gateway 80 for the tickets. The length 78 is marginally longer than the width of the tickets 12 dispensed by the apparatus 10. The guide 76 is slidably mounted in the platform 14 by the provision of interengaging rebates 82 formed in the platform 14 and laterally extending flanges 84 formed along the opposite lower edges of the guide 76. In this way, the guide 76 can be replaced or interchanged to suit the width of the tickets 12 being dispensed.

As can be seen from FIG. 2, a communications port 86 is mounted within a side of the platform 14 and is coupled to the controller retained within the base of the platform 14. The communications port 86 can be connected with an external input device such as a cash register or other input device to allow an operator or user of the apparatus 10 to input the number of tickets 12 required to be dispensed.

The apparatus 10 would typically be housed in a steel box or enclosure together with a supply of tickets 12 to be dispensed. The supply of tickets 12 can be formed in either a roll or carried in a fan fold manner. If held in a fan fold manner, the tickets could be either folded singularly or, in say groups of two or more, for example the joint tickets can be folded every five tickets. The apparatus 10 would be located within the box or enclosure so that the tickets being cut by the cutting disc 20 would extend through a discharge opening or chute formed in the box or enclosure and fall by action of gravity once cut through the opening or chute.

The operation of the apparatus 10 will now be described. Initially, the housing within which the apparatus 10 is held as opened and a supply of tickets 12 placed within the housing. The forward most ticket is passed through the gateway 80 and held between the rollers 36 and 38. The load/unload button 74 is operated to cause the rollers 36,38 to rotate in a direction so as to grip the forward most ticket and advance the tickets in the forward direction F. The housing is then shut. When it is desired to dispense one or more tickets 12, the number of tickets to be dispensed is input into an input device that communicates with the controller via the communication port 86.

In order to dispense this one ticket 12, an operator of the apparatus 10 inputs instructions to the input device to the effect that one ticket only is to be dispensed. The controller then operates motor 28 to advance the tickets 12 in the forward direction. When the markers 70 of the first adjacent joined tickets are located so as to be directly over the sensors 66,68, the sensors provide a signal back to the controller indicating that one ticket has passed, or at least is in alignment with, the cut line 22. As this coincides with the number of tickets to be dispensed, the controller then operates the motor 42 to slide the carriage 54 across rails 50,52 so that the cutting disc 20 cuts the tickets along cutting line 22 which coincides with the line of perforation 72 of the adjoined tickets. The single ticket now being cut from the stock of joined tickets falls by gravity through the discharge opening.

If say five tickets are to be dispensed, then the above process is repeated but everytime markers 70 of adjacent tickets are simultaneously detected by the detector 66,68 a feed back signal is provided to the controller which then counts the number of tickets passing across the cut line 22 and when this number equals five the carriage 54 is again traversed along the rails 50,52 to cut the tickets. In this mode of operation, the five tickets are dispensed in a serially joined condition, that is as a block of five joined tickets. However the controller can be programmed to cut each of the five tickets individually if desired.

Now that an embodiment of the present invention has been described in detail it will be apparent to those skilled in the relevant arts that numerous modifications and variations may be made without departing from the basic inventive concepts. For example, an additional, second set of rollers may be provided on the side of the cut line 22 opposite the first rollers 16 for the purpose of assisting in the ejecting of the cut tickets. Also, the foot 64 can be extended to extend, and indeed be fixed between the walls 24 and 26, and the bottom of the carriage 54 provided with a recess so as to slide over the foot 64 as it moves in opposite directions along the rails 50,52. Also, two or more apparatuses 10 may be connected in parallel by appropriate coupling of respective communication ports 86 so that a dispenser can dispense dual rolls or stocks of tickets. It is envisaged that the apparatus 10 will be connected with for example a cash register at a supermarket so that a purchaser of products from the supermarket can at the checkout purchase a number of tickets 12 with the purchase being made via the cash register which in turn can send instructions via communication port 86 to the controller to dispense the purchased number of tickets. Indeed, the apparatus 10 can be coupled with say a barcode scanner and used in the promotion of a particular product so that for example when a person purchases a particular product and that product is scanned through the barcode scanner at the checkout the scanner sends instructions to the controller to dispense a predetermined number of tickets. Also, the controller can arrange to maintain a count of tickets dispensed and the number of tickets remaining. The precise configuration and componentry of the controller are not important or critical features of this invention. The controller may be constructed using known electronic design techniques and practices and off-the-shelf components. All such modifications and variations together with others that would be obvious to a person of ordinary skill in the art are deemed to be within the scope of the present invention the nature of which is to be determined from the above description and the appended claims.

The Claims Defining the Invention are as Follows:

1. An apparatus for dispensing a selectable number of tickets from a plurality of serially joined tickets, the apparatus including:
a platform along which the joined tickets are constrained to travel toward a discharge opening in the apparatus;
first roller means for engaging the joined tickets and advancing the tickets in a forward direction towards the discharge opening;
cutting means adapted to cut adjacent joined tickets along a cut line; and,
a controller connectable to an input device for allowing entry of a selected number of tickets to be dispensed, said controller controlling the first roller and the cutting head to advance the joined tickets a distance in the forward direction commensurate with the selected number of tickets to be dispensed and cutting the selected number of tickets from the joined tickets whereby the selected number of tickets can be dispensed through the discharge opening.

2. The apparatus according to claim 1 further including detector means supported on said platform for detecting when said joined tickets are on opposite sides of said cut line and providing information to said controller to enable the controller to count to said selected number of tickets.

3. The apparatus according to claim 2 wherein said detector includes first and second sensors on each side of said cut line, each sensor adapted to sense the presence of a different marker on adjacent joined tickets.

4. The apparatus according to claim 3 wherein said cutting means is adapted to cut a ticket from the joined tickets when moving in opposite directions along said cut line.

5. The apparatus according to claim 4 wherein said cutting means is a rotatable cutting disc.

6. The apparatus according to claim 5 wherein said cutting disc is supported on a carriage mounted on a rail extending parallel to and behind said cut line, said rail disposed closed to said platform to assist in holding said joined tickets substantially flat against said platform.

7. The apparatus according to claim 6 further including holding means for holding the joined tickets substantially flat against the platform at a location above said detector means.

8. The apparatus according to claim 7 further including a ticket guide for constraining and guiding said joined tickets from a supply of said joined tickets onto said platform, said guide demountably coupled to the platform to allow interchanging of the ticket guide to suit joined tickets of different width.

9. A ticketing system including:
a supply of tickets serially joined in a line, each ticket provided on one side with two spaced apart markers, each marker being located along the opposite edges of the ticket that are joined to opposite adjacent tickets; and,
an apparatus for dispensing a selectable number of said joined tickets, the apparatus having:
a platform along which joined tickets are constrained to travel toward a discharge opening in the apparatus;
first roller means for engaging the joined tickets and advancing the tickets in a forward direction to the dispenser opening;
cutting means adapted to cut adjacent joined tickets along a cut line formed of said platforms;
detector means supported on said platform for detecting when respective markers on adjacent joined tickets are located on opposite sides of said cut line; and,
a controller connectable to an input device for allowing entry of the selected number of tickets to be dispensed, said controller controlling the first roller means and the cutting head to advance the joined tickets a distance in the forward direction commensurate with the selected number of tickets to be dispensed and cutting the selected number of tickets from the joined tickets, said detecting means providing a feed back signal to the controller to enable the controller to count to said selected number whereby the selected number of tickets can be dispensed through the dispenser opening.
